(19) United States
(12) Patent Application Publication
(10) Pub. No.: US 2010/0211471 A1
(43) Pub. Date: Aug. 19, 2010

(54) COMMODITY SALE DATA PROCESSING APPARATUS AND CONTROL METHOD FOR THE SAME

(75) Inventor: Takuzo Haibara, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/703,921

(22) Filed: Feb. 11, 2010

(30) Foreign Application Priority Data
Feb. 13, 2009 (JP) 2009-031475

(51) Int. Cl. G06Q 30/00

(52) U.S. Cl. 705/21; 705/24

(57) ABSTRACT

A receipt detection unit which detects the presence of a receipt issued by a receipt issuing unit provided in a commodity sale data processing apparatus, and an operator detection unit which detects the presence of an operator of the apparatus, are provided. Then, it is notified that a receipt is left on condition that the receipt is detected by the receipt detection unit and the operator is not detected by the operator detection unit.

### CROSS-REFERENCE TO RELATED APPLICATION

This application is based upon and claims the benefit of priority from the prior Japanese Patent Application No. 2009-031475, filed on Feb. 13, 2009, the entire contents of which are incorporated herein by reference.

### TECHNICAL FIELD

The present invention relates to a commodity sale data processing apparatus having a receipt issuing function and a control method for the same.

### BACKGROUND

As a conventional technique related to the invention, for example, an electronic device described in JP-A-2003-85649 is known. This electronic device includes a receipt issuing function and a detection unit which is provided in a receipt discharge section and detects whether there is a receipt or not. The electronic device notifies that a receipt guided to the customer side is left by the customer.

Recently, a POS terminal employing a self-checkout system is broadly used. In the case of checking out using this POS terminal, the customer registers an article by himself or herself, then place the article into a checkout bag, insert money for the price, take out discharged change, and acquires an issued receipt.

Customers have many opportunities to experience the takeout of change from a change discharge port, by using vending machines or the like. However, since there are normally fewer opportunities to experience the acquisition of a receipt, many customers forget to take and leave the receipt. If, in order to cope with this, a detection unit which is similar to that of the electronic device described in JP-A-2003-85649 notifies that the receipt is left, it is probable that the leaving of the receipt can be notified of while the customer is putting change into a purse or bag. Such a notification of the leaving of the receipt might incur the customer's displeasure.

### SUMMARY

In view of the foregoing circumstances, an object of the invention is to provide a commodity sale data processing apparatus that adequately detects that a receipt is left and can prevents a customer from leaving the receipt without arousing the customer's displeasure, and a control method for the same.

According to an aspect of the invention, a commodity sale data processing apparatus includes: a receipt issuing unit which issues a receipt having information about a transaction printed thereon; a receipt detection unit which detects the presence of the receipt issued by the receipt issuing unit; an operator detection unit which detects the presence of an operator of the apparatus; and a notification control unit which notifies that the receipt is left, on condition that the receipt is detected by the receipt detection unit and the operator is not detected by the operator detection unit.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows the configuration of a network system having a POS terminal according to an embodiment of the invention.

FIG. 2 is a perspective view showing the appearance of the POS terminal.

FIG. 3 is a block diagram showing a control circuit of the POS terminal.

FIG. 4 is a schematic view illustrating a receipt sensor provided in the POS terminal.

FIG. 5 is a flowchart showing processing executed by a CPU of the POS terminal.

### DETAILED DESCRIPTION

Hereinafter, an embodiment of the invention will be described with reference to the drawings.

This embodiment is an example in which a commodity sale data processing apparatus according to the invention is applied to a self-checkout POS terminal 1 used in a commodity retail store such as a supermarket or convenience store.

FIG. 1 shows the configuration of a network system having the POS terminal 1. This system includes plural POS terminals 1 and an attendant PC 2 as a superordinate device which are connected via a network hub 3 so that the POS terminals 1 and the attendant PC 2 can communicate with each other. If an error occurs at each POS terminal 1, the POS terminal 1 where the error occurs creates an error status to notify of the error type and sends the error status to the attendant PC 2. The attendant PC 2 displays, on a display device, an error notification screen based on the error status received from the POS terminal 1 in order to notify the attendant what kind of error is generated at which POS terminal 1. After confirming the error notification screen, the attendant moves to the place where the POS terminal 1 with the occurrence of the error is installed, and copes with the error.

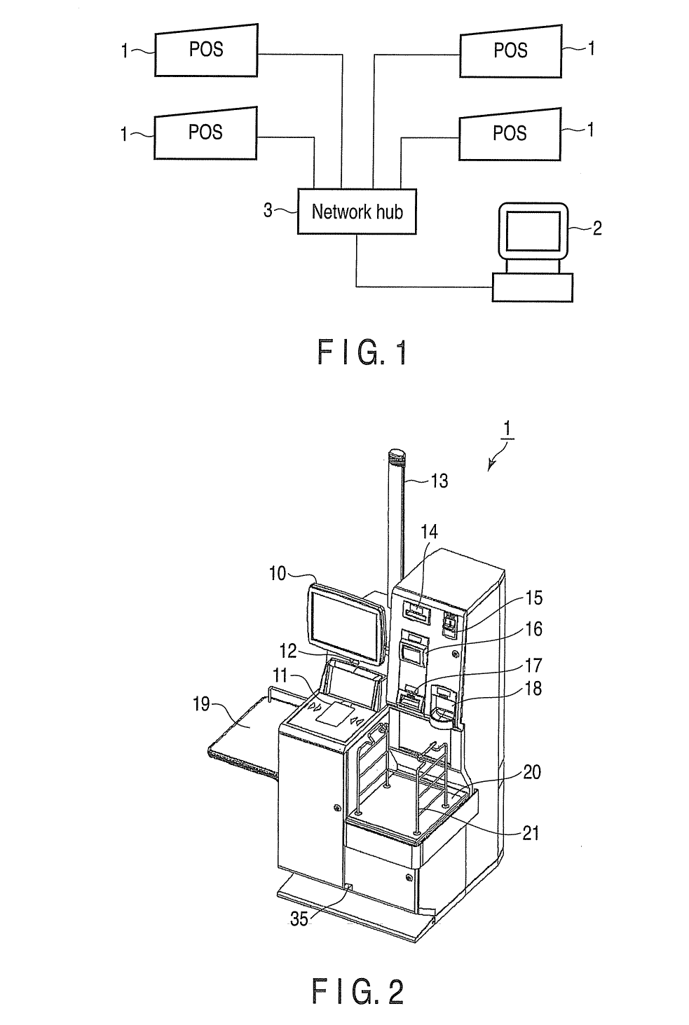

FIG. 2 shows a perspective view of the appearance of the POS terminal 1. The POS terminal 1 includes, in its body, a display 10 with a touch panel to display operation guidance information and so on, a scanner 11, a speaker 12, a communication unit 13, a receipt issuing port 14, a coin insertion port 15, a banknote insertion port 16, a banknote discharge port 17, a coin discharge port 18, an unsettled-side article placing table 19, a settled-side article placing table 20, a pair of bag holding members 21, and a human detection sensor 35.

The display 10 selectively displays operation guidance information or the like. The scanner 11 is a fixed barcode scanner which scans a barcode attached to an article held over a scanning window. The speaker 12 selectively outputs an operation sound, a sound of operation guidance or the like. The communication unit 13 functions as a communication unit in this embodiment and controls data communication with the attendant PC 2. A receipt that is printed within the body is discharged from the receipt issuing port 14. Coins for payment of the price by a customer are inserted in the coin insertion port 15. Banknotes for payment of the price by the customer are inserted in the banknote insertion port 16. Banknotes of change are discharged from the banknote discharge port 17. Coins of change are discharge from the coin discharge port 18. An article before an article code is inputted is placed on the unsettled-side article placing table 19. The settled-side article placing table 20 functions as a placing unit in this embodiment and an article with its barcode scanned by the scanner 11 is placed on this table. A pair of grip parts of each checkout bag is hooked on the pair of bag holding members 21, respectively, in a manner that the opening of each checkout bag opens upward. The human detection sensor 35 functions as an operator detection unit in this embodiment. The human detection sensor 35 is, for example, a pyroelectric infrared sensor which detects weak infrared rays emitted from a human body. The human detection sensor 35 detects the presence of a customer standing near the position for operating the POS terminal 1.

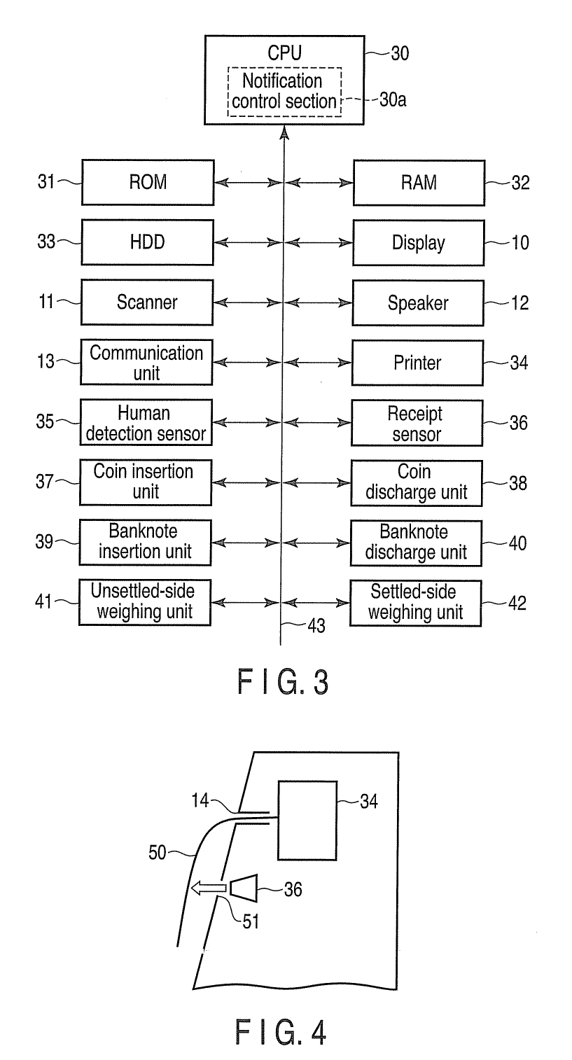

FIG. 3 shows a block diagram of a control circuit of the POS terminal 1. The POS terminal 1 has, within itself, a CPU 30 which functions as a control center. A ROM 31, a RAM 32, an HDD (hard disk drive) 33, the display 10, the scanner 11, the speaker 12, the communication unit 13, a printer 34, the human detection sensor 35, a receipt sensor 36, a coin insertion unit 37, a coin discharge unit 38, a banknote insertion unit 39, a banknote discharge unit 40, an unsettled-side weighing unit 41, and a settled-side weighing unit 42 are connected to the CPU 30 via a bus line 43.

In the ROM 31, fixed data such as control programs are stored. In the RAM 32, various work memory areas corresponding to processing situations are formed. In the HDD 33, various application programs and databases are stored. The printer 34 functions as a receipt issuing unit in this embodiment. The printer 34 prints information such as transaction details on a receipt sheet wound in a roll and discharges the receipt from the receipt issuing port 14. The receipt sensor 36 functions as a receipt detection unit in this embodiment and detects the presence of a receipt discharged from the receipt issuing port 14. The coin insertion unit 37 counts the amount of coins inserted from the coin insertion port 15. The coin discharge unit 38 discharges coins of change from the coin discharge port 18. The banknote insertion unit 39 counts the amount of banknotes inserted from the banknote insertion port 16. The banknote discharge unit 40 discharges banknotes of change from the banknote discharge port 17. The unsettled-side weighing unit 41 measures the weight of an article placed on the unsettled-side article placing table 19. The settled-side weighing unit 42 functions as an article detection unit in this embodiment and measures the weight of an article placed on the settled-side article placing table 20.

The CPU 30 has a notification control section 30a. The notification control section 30a notifies that a receipt issued from the printer 34 is left, using an output interface provided in the POS terminal 1 on the basis of the results of the detection by the receipt sensor 36, the human detection sensor 35 and the settled-side weighing unit 42.

FIG. 4 is a schematic view for explaining the operation of the receipt sensor 36. The receipt sensor 36 is, for example, a reflection sensor which detects reflection of an ultrasonic wave or light emitted by the sensor itself and thus detects the presence of an object. A receipt sheet 50 on which information such as transaction details are printed by the printer 34 is discharged outside of the POS terminal 1 from the receipt issuing port 14. At this time, a cutter, not shown, is driven to cut the part of the receipt sheet 50 where the information is printed, but this part is partly left connected to the sheet instead of being completely cut off. In this way, the part of the receipt sheet 50 where the information is printed stands still, suspended from the receipt issuing port 14 until the operator removes this part of the receipt sheet by hand. Below the receipt issuing port 14, a small hole 51 is provided through which the receipt sensor 36 radiates an ultrasonic wave or the like and detects a reflected wave. The small hole 51 is positioned so that the distance from the receipt issuing port 14 becomes sufficiently shorter than the length of a receipt for one transaction. Therefore, when a receipt is issued from the receipt issuing port 14, the receipt sensor 36 detects the presence of the receipt unless the operator removes the receipt by hand.

Next, the basic operation of the POS terminal 1 will be described. The POS terminal 1 starts sale processing of articles in response to a customer's action of placing a shopping bag with articles therein, on the unsettled-side article placing table 19. In the sale processing of articles, the customer takes out articles one after another from the shopping bag placed on the unsettled-side article placing table 19 and holds a barcode attached to each article over the scanner 11. At this time, the barcode is scanned by the scanner 11 and an article code is inputted. On the basis of the article code, article data including price, name and so on is acquired from an article master stored in the HDD 33 and is registered to an article registration area for this transaction formed in the RAM 32. The customer puts the articles for which barcode scanning is completed into a checkout bag hooked on the pair of bag holding members 21. Then, as registration of all the articles is finished, the customer operates a subtotal button displayed on the display 10 and declares completion of the registration. Accordingly, the CPU 30 calculates the price based on the article data registered in the article registration area. The calculated price is displayed on the display 10. At this time, banknotes inserted in the banknote insertion port 16 and coins inserted in the coin insertion port 15 by the customer are counted as a deposit amount by the banknote insertion unit 39 and the coin insertion unit 37. Then, the difference between the deposit amount and the subtotal amount is calculated. Banknotes of change are discharged from the banknote discharge port 17 by the banknote discharge unit 40. Coins of change are discharged from the coin discharge port 18 by the coin discharge unit 38. After that, the issuance of a receipt is started.

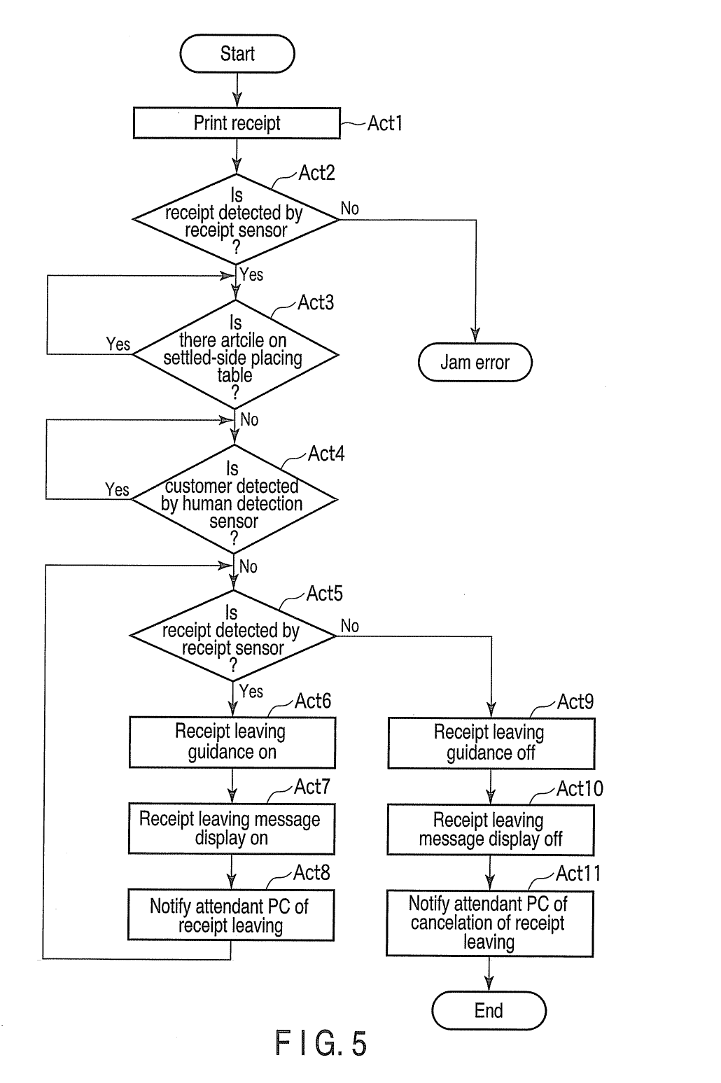

FIG. 5 is a flowchart showing processing executed by the CPU 30 in the issuance of a receipt. First, the CPU 30 creates print data for a receipt with reference to the article data registered in the article registration area and causes the printer 34 to print a receipt according to the created print data (ACT 1). After that, it is determined whether the receipt is detected by the receipt sensor 36 or not (ACT 2). If the receipt is not detected by the receipt sensor 36 (No in ACT 2), it is highly probable that the receipt sheet is jammed in the printer 34. Therefore, the CPU 30 causes the display 10 to display a message that there is a jam error.

Meanwhile, when the receipt is detected by the receipt sensor 36 (Yes in ACT 2), the CPU 30 determines whether an article is placed on the settled-side article placing table 20 or not (ACT 3). In this case, when the weight of an article is detected by the settled-side weighing unit 42, the CPU 30 determines that an article is placed on the settled-side article placing table 20 (Yes in ACT 3). On the other hand, when the weight of an article is not detected by the settled-side weighing unit 42, the CPU 30 determines that an article is not placed on the settled-side article placing table 20 (No in ACT 3).

Next, the CPU 30 determines whether the presence of a customer is detected by the human detection sensor 35 or not (ACT 4). When a customer is present within the detection range of the human detection sensor 35, the presence of the customer is detected by the human detection sensor 35 (Yes in ACT 4).

After that, as the customer leaves the peripheries of the POS terminal 1, the human detection sensor 35 stops detecting any customer (No in ACT 4). At this time, the CPU 30 determines again whether a receipt is detected by the receipt sensor 36 or not (ACT 5). When a receipt is detected by the receipt sensor 36 (Yes in ACT 5), the CPU 30 causes the speaker 12 to generate a message or warning sound alerting that the receipt is left (ACT 6) and causes the display 10 to display a message alerting that the receipt is left (ACT 7). Moreover, the CPU 30 sends an error status that the receipt is left, to the attendant PC 2 via the network hub 3 through wireless communication using the communication unit 13 (ACT 8). After that, the CPU 30 repeats the processing of ACT 6 to ACT 8 until no receipt is detected any more by the receipt sensor 36.

Then, when no receipt is detected any more by the receipt sensor 36 (No in ACT 5), the CPU 30 causes the speaker 12 to stop generating the message or warning sound alerting that the receipt is left (ACT 9). The CPU 30 also causes the display 10 to delete the message alerting that the receipt is left (ACT 10). After that, the CPU 30 causes the communication unit 13 to send an error cancelation status that the leaving of the receipt is canceled, to the attendant PC 2 via the network hub 3 (ACT 11). The CPU 30 then ends the issuance of the receipt.

As described above, in the POS terminal 1 in this embodiment, it is notified that a receipt is left on condition that a receipt is detected by the receipt sensor 36 and the presence of a customer is not detected by the human detection sensor 35. Therefore, while the customer is collecting change or the like near the POS terminal 1, it is not notified that a receipt is left. Thus, the customer's displeasure is not aroused. Moreover, it is notified that a receipt is left on condition that an article is not placed on the settled-side article placing table 20. Therefore, even if the customer moves for a certain reason to a position that cannot be detected by the human detection sensor 35, it is not notified that a receipt is left as long as an article is placed.

Also, the attendant PC 2 is notified that a receipt is left, via the communication unit 13 from the POS terminal 1. Therefore, the attendant can grasp the occurrence of the leaving of a receipt and prompt the customer making a payment at the POS terminal 1 where the receipt is left, to take the receipt.

In the above embodiment, the case where the invention is applied to the POS terminal 1 employing the self-checkout system is described. However, the invention can also be applied to a commodity sale data processing apparatus employing a system in which a cashier carries out checkout.

The processing of ACT 3 and the processing of ACT 4 may be replaced in order so that it can be determined whether an article is placed on the settled-side article placing table 20 or not, after the presence of a customer is no longer detected by the human detection sensor 35.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A commodity sale data processing apparatus comprising:
a receipt issuing unit which issues a receipt having information about a transaction printed thereon;
a receipt detection unit which detects the presence of the receipt issued by the receipt issuing unit;
an operator detection unit which detects the presence of an operator of the apparatus; and
a notification control unit which notifies that the receipt is left, on condition that the receipt is detected by the receipt detection unit and the operator is not detected by the operator detection unit.

2. The apparatus of claim 1, further comprising a communication unit which communicates with a superordinate device,
wherein the notification control unit notifies that the receipt is left, to the superordinate device via the communication unit.

3. The apparatus of claim 1, wherein a self-checkout system is employed in which a customer operates the apparatus to complete checkout.

4. The apparatus of claim 1, wherein after starting a notification that the receipt is left, the notification control unit ends the notification in response to a fact that the receipt is no longer detected by the receipt detection unit.

5. A commodity sale data processing apparatus comprising:
a receipt issuing unit which issues a receipt having information about a transaction printed thereon;
a receipt detection unit which detects the presence of the receipt issued by the receipt issuing unit;
an operator detection unit which detects the presence of an operator of the apparatus;
a placing unit on which a purchased article is placed;
an article detection unit which detects the presence of the article placed on the placing unit; and
a notification control unit which notifies that the receipt is left, on condition that the receipt is detected by the receipt detection unit, the operator is not detected by the operator detection unit, and the article is not detected by the article detection unit.

6. The apparatus of claim 5, wherein the article detection unit detects the presence of the article by detecting the weight of the article placed on the placing unit.

7. The apparatus of claim 5, further comprising a communication unit which communicates with a superordinate device,
wherein the notification control unit notifies that the receipt is left, to the superordinate device via the communication unit.

8. The apparatus of claim 5, wherein a self-checkout system is employed in which a customer operates the apparatus to complete checkout.

9. The apparatus of claim 5, wherein after starting a notification that the receipt is left, the notification control unit ends the notification in response to a fact that the receipt is no longer detected by the receipt detection unit.

10. A control method for a commodity sale data processing apparatus including a receipt issuing unit which issues a receipt having information about a transaction printed thereon, a receipt detection unit which detects the presence of the receipt issued by the receipt issuing unit, and an operator detection unit which detects the presence of an operator of the apparatus, the method comprising:
detecting the receipt by the receipt detection unit;
detecting the presence of the operator of the apparatus by the operator detection unit; and
notifying that the receipt is left, on condition that the receipt is detected by the receipt detection unit and the operator of the apparatus is not detected by the operator detection unit.
